(19) United States
(12) Patent Application Publication
(10) Pub. No.: US 2006/0002670 A1
(43) Pub. Date: Jan. 5, 2006

(54) Light-emitting gift combined with foggy and color-changing ball

(76) Inventor: Cheng-Fu Lin, Taipei Hsien (TW)

Correspondence Address: BACON & THOMAS, PLLC, 625 SLATERS LANE, FOURTH FLOOR, ALEXANDRIA, VA, 22314, US

(21) Appl. No.: 10/879,129

(22) Filed: Jun. 30, 2004

(51) Int. Cl. G02B 6/04; F21V 8/00

(52) U.S. Cl. 385/115; 385/901; 362/554

(57) ABSTRACT

The present invention is to provide a light-emitting device comprising a hollow body having a base, a first and a second light sources on the base, at least one optical fiber section provided on the body, a frame element provided on the body and a foggy and color-changing ball supported on the frame element, wherein the activated first and second light sources are able to emit light to the optical fiber section and the foggy and color-changing ball respectively such that a plurality of optical fibers as the constituent components of the optical fiber section are able to transmit light to the body after collecting the light, and the foggy and color-changing ball is adapted to show a foggy and color-changing effect in addition to the light-emitting effect.

### FIELD OF THE INVENTION

The present invention relates to gifts, more particularly to a light-emitting gift having a base on one side thereof for installing a foggy and color-changing ball and showing a foggy and color-changing effect in addition to the light-emitting effect.

### BACKGROUND OF THE INVENTION

A wide variety of specially designed, attractive gifts are constantly available from gift manufacturers as a result of the technological advancements. For example, some gifts having the appearance of flower, human being, animal, or monster and being capable of emitting light are available by taking advantage of the transmission of light of fiber optics. In detail as shown in a well known light-emitting gift 6 of FIG. 1, one ends of a plurality of optical fibers are provided in suitable positions of a gift 6 (e.g., wings of an angel or a dragon) and the other ends thereof are formed as a bundle on a bottom of the gift 6. A light-emitting member provided on the bottom of the gift 6 is adapted to emit light onto the bundle. And in turn, light is transmitted from the bundle at the other ends to one ends of the optical fibers. As an end, a dazzling effect is occurred on the gift.

Also, a type of foggy and color-changing ball 7 is commercially available, as shown in FIG. 2, the foggy and color-changing ball 7 is implemented as a transparent enclosed ball filled with liquid (e.g., water) and additive (e.g., nonsolvent color paste) which are well mixed to form a jellylike mixture. Further, a magnetic rotation member is pivotably provided in a lower portion of the ball 7. A motor is provided outside the ball 7 and is in a position lower than and corresponding to the rotation member. The motor has a shaft extended into the rotation member so that the rotation member is able to space apart from the ball 7 and rotatably couple to the shaft by means of magnetism. The shaft rotates when the motor is activated. And in turn, the rotation member rotates as the shaft rotates. Thus, the mixture is agitated by the rotation member. As an end, a foggy, turbulent effect can be seen from outside of the ball 7.

Moreover, a control circuit board is provided adjacent the motor and is external to the ball 7. The control circuit board comprises a plurality of LEDs (light-emitting diodes) each being adapted to emit light having a color different from the others. The control circuit board is adapted to activate the LEDs to emit light in turn. Further, the emitted light is impinged on an inner surface of the ball 7. A ball having a continuous change of color is thus made by collecting the emitted light.

However, the prior foggy and color-changing ball and the light-emitting gift are two separate gifts as available in the market. A consumer has to buy either one or both of them for achieving respective, decorative purpose(s). Thus, it is desirable among the related manufacturers to provide a novel light-emitting gift by combining the prior foggy and color-changing ball with the prior light-emitting gift such that a new business opportunity can be created and a unique, decorative, attractive, and aesthetic gift is presented to the vast consumers.

### SUMMARY OF THE INVENTION

After considerable research and experimentation, a light-emitting gift combined with a foggy and color-changing ball according to the present invention has been devised so as to overcome the above drawback of the prior art.

One object of the present invention is to provide a light-emitting device comprising a hollow body having a base; a first light source on the base adjacent one side; at least one optical fiber section provided on the body adjacent the other side, a second light source provided on the base and located at an opposite side of the first light source; a frame element provided on the body opposite the second light source; and a foggy and color-changing ball supported on the frame element. The activated first and second light sources are able to emit light to the optical fiber section and foggy and color-changing ball respectively such that a plurality of optical fibers as the constituent components of the optical fiber section are able to transmit light to the body after collecting the light. Also, the foggy and color-changing ball is adapted to show a continuous change of color. By utilizing the present invention, it is possible of showing a foggy and color-changing effect in addition to the light-emitting effect.

The above and other objects, features and advantages of the present invention will become apparent from the following detailed description taken with the accompanying drawings.

### BRIEF DESCRIPTION OF THE DRAWINGS

FIG. 1 is a perspective view of a conventional light-emitting gift;

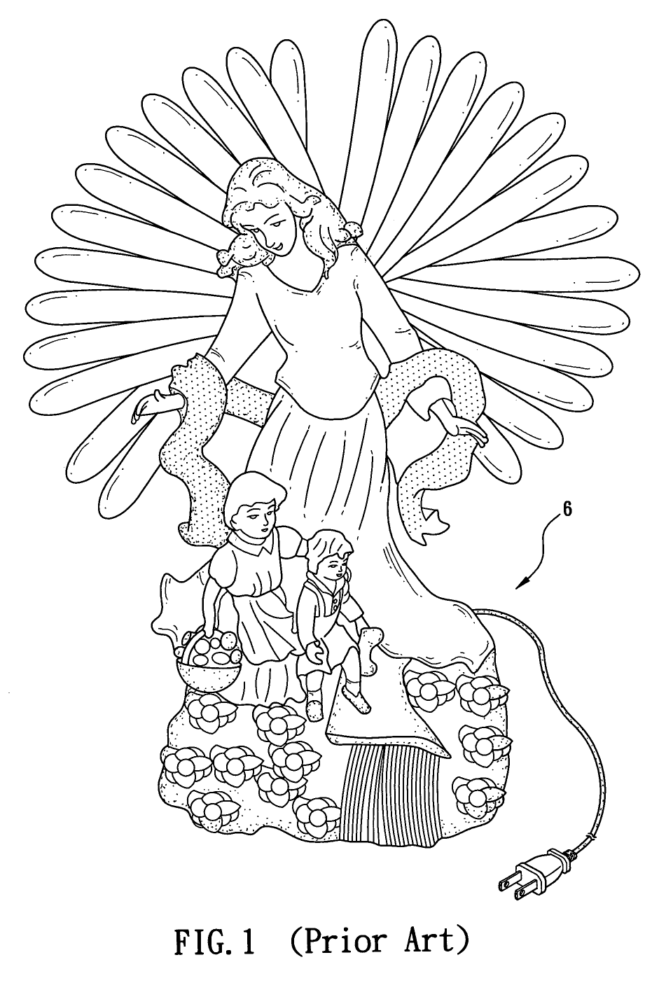

FIG. 2 is a perspective view of a conventional foggy and color-changing ball;

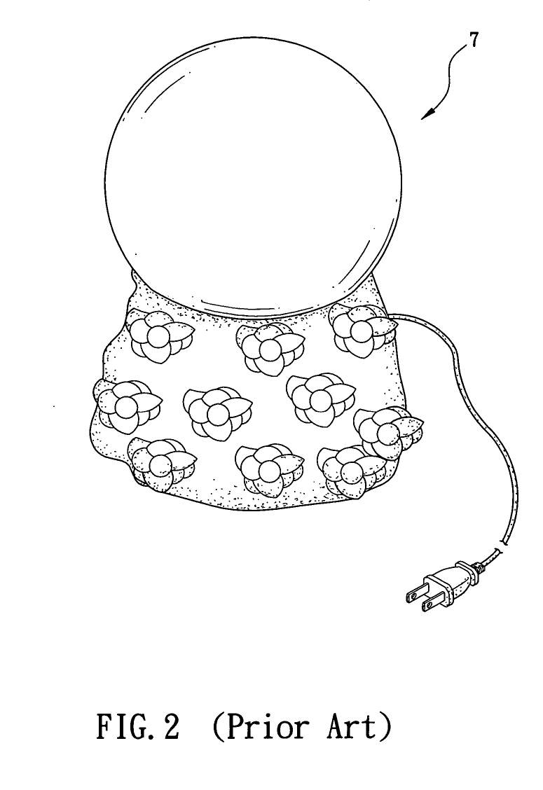

FIG. 3 is a perspective view of a preferred embodiment of light-emitting gift according to the invention;

FIG. 4 is an exploded view of the light-emitting gift of FIG. 3;

FIG. 5 is an exploded view of the first light source according to the invention; and

FIG. 6 is a block diagram of the second light source according to the invention.

### DETAILED DESCRIPTION OF THE PREFERRED EMBODIMENTS

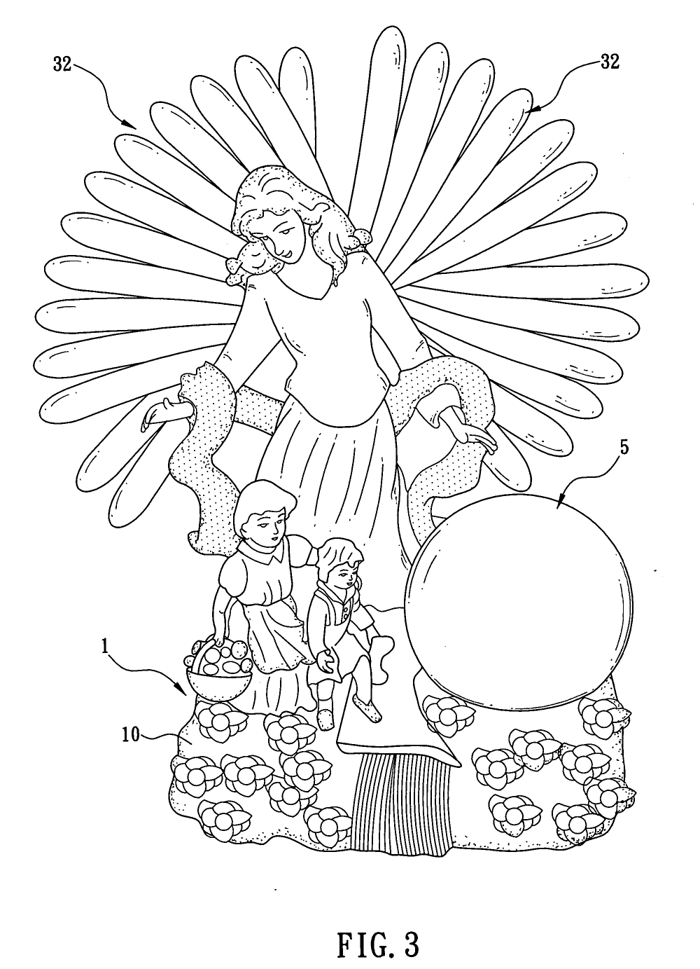

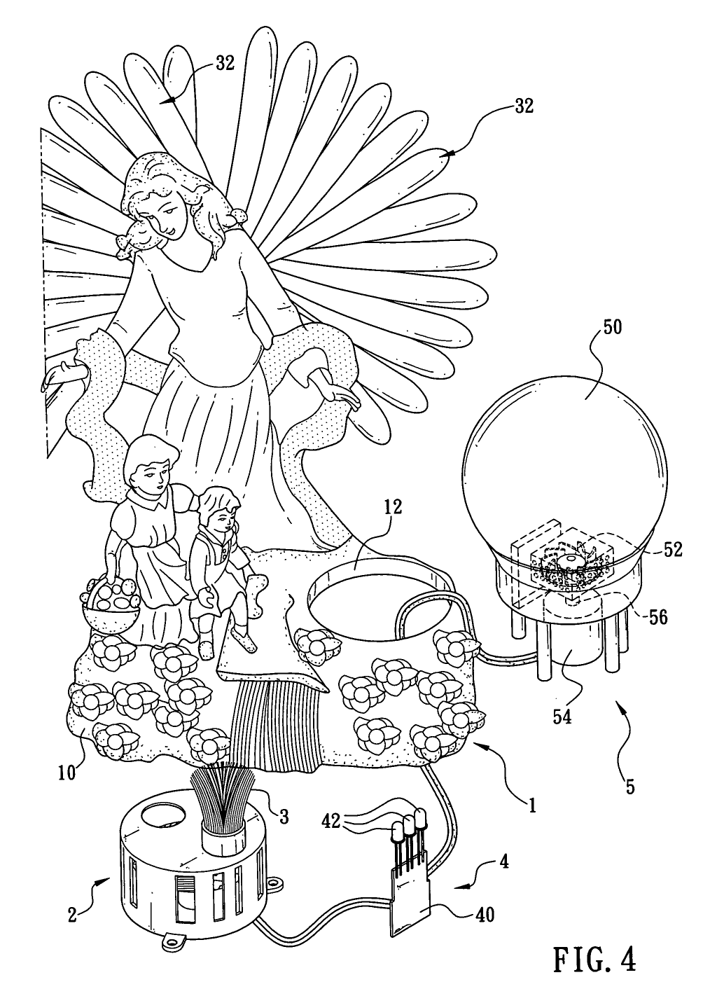

Referring to FIGS. 3 and 4, there is shown a light-emitting gift combined with a foggy and color-changing ball in accordance with the invention. The light-emitting gift is implemented as a hollow body 1 including a base 10 having an internal first light source 2 adjacent one side. At least one optical fiber section 3 (one is shown) is provided on the body 1 corresponding to the first light source 2. The optical fiber section 3 comprises a plurality of optical fibers 30 bundled together. A second light source 4 is provided on the base 10 and is located at an opposite side of the first light source 2. A frame element 12 is provided on the body 1 and is opposite to the second light source 4. A foggy and color-changing ball 5 is supported by the frame element 12. The activated first light source 2 and the second light source 4 are adapted to emit light onto the optical fiber section 3 and the foggy and color-changing ball 5 respectively. And in turn, the optical fibers 30 are adapted to transmit light to the inner surface of the body 1. Also, a continuous change of color is observed on the foggy and color-changing ball 5. In such a manner, the colorful, foggy and color-changing ball 5 is additionally provided by the body 1.

In a preferred embodiment of the invention, the other ends of the optical fibers 30 opposite the first light source 2 are extended away from the base 10. One or more light-emitting members 32 are formed at the other ends of the optical fibers 30 on the body 1. For example, the body 1 has the shape of an angel or a dragon and thus the light-emitting members 32 have the shape of the extended wings. The first light source 2 is adapted to sequentially emit light of different colors to the optical fiber section 3. And in turn, light of different colors is transmitted from the optical fibers 30 to the light-emitting members 32.

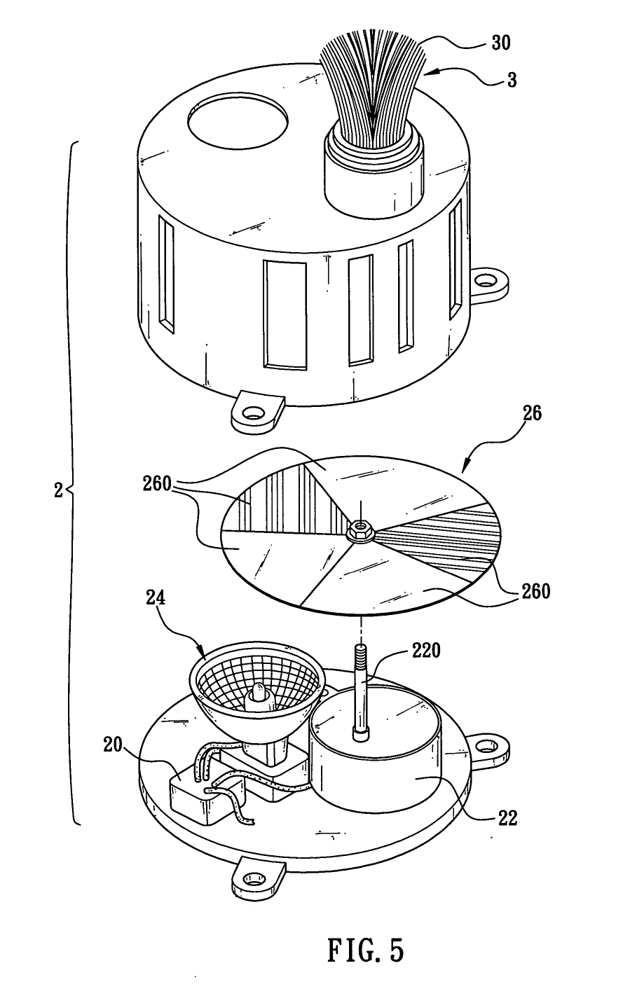

Referring to FIG. 5, in the embodiment the hollow, cylindrical first light source 2 comprises a power supply 20, a first driver (e.g., motor) 22, a lamp (e.g., halogen lamp) 24, and a transparent disc 26. The power supply 20 is provided on a top of the base 10 and is electrically energized by a transformer (not shown). The power supply 20 is coupled to the first driver 22 and the lamp 24 respectively for supplying power thereto. The lamp 24 is also provided on the base 10 facing the optical fiber section 3. The first driver 22 is provided adjacent the lamp 24 on the base 10. The first driver 22 has a projected shaft 220 extended toward inside of the body 1. The transparent disc 26 has its central hole put on and secured to the shaft 220. The edge of the transparent disc 26 is disposed above the lamp 24. The transparent disc 26 is divided into a plurality of pies (five are shown) 260 having different patterns of stripe or colors. The shaft 220 rotates when the first driver 22 activates. Also, the lamp 24 is lit. The transparent disc 26 rotates as the shaft 20 rotates such that each of the pies 260 of the transparent disc 26 is able to dispose above the lamp 24 by rotation. The pie 260 is adapted to transmit light emitted from the lamp 24. As such, lit patterns of stripe and different colors can be seen on the top of the pie 260 facing the optical fiber section 3. Eventually, the lit patterns of stripe and different colors are transmitted to the optical fiber section 3.

Referring to FIG. 4 again, the foggy and color-changing ball 5 is implemented as a transparent enclosed ball 50 filled with liquid (e.g., water) and additive (e.g., nonsolvent color paste) which are well mixed to form a jellylike mixture. Further, a magnetic rotation member 52 is pivotably provided in a lower portion of the ball 50. A second driver (e.g., motor) 54 is provided on the base 10 adjacent the second light source 4 and is in a position lower than and corresponding to the rotation member 52. The second driver 54 has a shaft 56 extended into the rotation member 52 so that the rotation member 52 is able to space apart from the ball 50 and rotatably couple to the shaft 56 by means of magnetism. The shaft 56 rotates when the second driver 54 is activated. And in turn, the rotation member 52 rotates as the shaft 56 rotates. Thus, the mixture is agitated by the rotation member 52. As an end, a foggy, turbulent effect can be seen from outside of the ball 50.

In view of the above, the optical fibers 30 are adapted to transmit light of different colors as time passes. Hence, different colors are shown on different locations of the optical fibers (i.e., colorful). At the same time, a foggy, turbulent, and color changing effect can be seen on the foggy and color-changing ball 5. As a result, the body 1 shows a combination effect distinctly different from a single light-emitting gift and a single foggy and color-changing ball of the prior art.

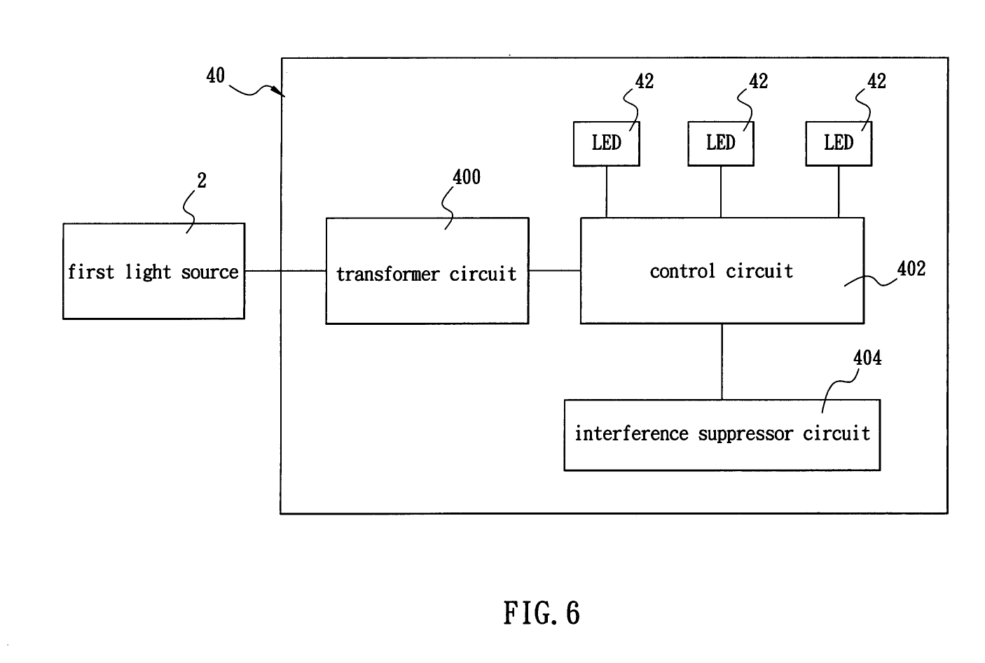

In the embodiment of FIGS. 4 and 6, the second light source 4 comprises a circuit board 40 and a plurality of light emitting elements (e.g., LEDs) 42. The circuit board 40 comprises a transformer circuit 400 and a control circuit 402. The transformer circuit 400 is coupled to the first light source 2 for being electrically energized by the first light source 2 and converting power supplied from the first light source 2 into a power to be supplied to the control circuit 402. The control circuit 402 is coupled to the light emitting elements 42 so as to cause the light emitting elements 42 to emit light of different colors sequentially. As a result of the light of different colors emitted by the light emitting elements 42, a continuous change of color can be seen on the surface of the ball 50 and the mixture. Referring to FIG. 6 again, in the embodiment the control circuit 402 is a control chip (e.g., 3 LED output control IC, type MT-3179 by Chenre electronics company). However, the control chip may not function normally if a temporal electrical surge is generated by switching power on the other electrical device (e.g., fluorescent lamp). As a result, the second light source 4 cannot emit light. Thus, in the embodiment an interference suppressor circuit 404 is provided on the control circuit 402 of the circuit board 40. The interference suppressor circuit 404 is adapted to eliminate the adverse effect of the temporal electrical surge on the control circuit 402. In the embodiment, the interference suppressor circuit 404 is implemented as a capacitor parallel to the control circuit 402. Hence, the adverse effect of the temporal electrical surge on the second light source 4 can be eliminated by the capacitor by absorbing the temporal electrical surge.

In another preferred embodiment of the invention, in the loop of the control circuit 402 of the circuit board 40 it is possible of eliminating the adverse effect of the temporal electrical surge on the control circuit 402 by decreasing the resistance of the control circuit 402.

While the invention has been described by means of specific embodiments, numerous modifications and variations could be made thereto by those skilled in the art without departing from the scope and spirit of the invention set forth in the claims.

What is claimed is:

1. A light-emitting device comprising:
a hollow body;
a base provided on a bottom of the body;
a first light source on the base adjacent one side;
at least one optical fiber section provided on the body corresponding to the first light source, the optical fiber section including a plurality of optical fibers bundled together and being adapted to collect light emitted from the first light source and transmit the same to the body;
a second light source provided on the base and located at an opposite side of the first light source;
a frame element provided on the body opposite the second light source; and
a foggy and color-changing ball supported on the frame element, the foggy and color-changing ball being adapted to collect light emitted from the second light source for showing a continuous change of color.

2. The light-emitting device of claim 1, wherein the other ends of the optical fibers opposite the first light source are extended away from the base to form one or more light-emitting members on the body, the first light source is adapted to sequentially emit light of different colors to the optical fiber section, and the light of different colors is transmitted from the optical fibers to the light-emitting members.

3. The light-emitting device of claim 2, wherein the first light source comprises:
a power supply provided on the base and electrically energized by a transformer;
a lamp provided on the base facing the optical fiber section and coupled to the power supply for being electrically energized thereby;
a first driver provided adjacent the lamp on the base and coupled to the power supply for being electrically energized thereby, the first driver having a projected shaft extended toward inside of the body; and
a transparent disc rotatably coupled to the shaft of the first driver wherein an edge of the transparent disc is disposed above the lamp, the transparent disc is divided into a plurality of pies having different patterns of stripe or colors, the shaft of the first driver rotates when the first driver activates, the lamp is lit, the transparent disc rotates as the shaft of the first driver rotates, and each of the pies of the transparent disc is able to dispose above the lamp by rotation for transmitting light emitted from the lamp such that lit patterns of stripe and different colors are shown on a top of the pie facing the optical fiber section and are transmitted to the optical fiber section.

4. The light-emitting device of claim 1, wherein the foggy and color-changing ball:
a transparent enclosed ball filled with liquid and additive mixed to form a jellylike mixture, the ball having a magnetic rotation member pivotably provided in a lower portion thereof; and
a second driver provided on the base adjacent the second light source and being in a position lower than and corresponding to the rotation member, the second driver having a shaft extended into the rotation member such that the rotation member is able to space apart from the ball and rotatably couple to the shaft of the second driver by means of magnetism, the shaft of the second driver rotates when the second driver is activated, and the rotation member rotates as the shaft of the second driver rotates.

5. The light-emitting device of claim 1, wherein the second light source comprises:
a circuit board including a transformer circuit and a control circuit wherein the transformer circuit is coupled to the first light source for being electrically energized by the first light source and converting power supplied from the first light source into a power to be supplied to the control circuit; and
a plurality of light emitting elements provided on and coupled to the circuit board for causing the light emitting elements to emit light of different colors sequentially such that in response to the light of different colors emitted by the light emitting elements, a continuous change of color is shown on a surface of the ball and the mixture.

6. The light-emitting device of claim 5, wherein the control circuit is a control chip, and the light-emitting device further comprising an interference suppressor circuit provided the control circuit of the circuit board, the interference suppressor circuit being adapted to eliminate a temporal electrical surge.

7. The light-emitting device of claim 6, wherein the interference suppressor circuit is a capacitor parallel to the control circuit, the capacitor being adapted to absorb the temporal electrical surge.

8. The light-emitting device of claim 6, wherein in a loop of the control circuit of the circuit board it is possible of eliminating the temporal electrical surge on by decreasing a resistance of the control circuit.
